(19) United States
(12) Patent Application Publication
(10) Pub. No.: US 2010/0171413 A1
(43) Pub. Date: Jul. 8, 2010

(54) PROCESS FOR THE PREPARATION OF A LINE-EMITTER PHOSPHOR

(76) Inventors: Holger Winkler, Darmstadt (DE); Tim Vosgroene, Siegen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/303,595

(22) PCT Filed: May 9, 2007
(86) PCT No.: PCT/EP07/04075

§ 371 Date: Dec. 5, 2008

(30) Foreign Application Priority Data
Jun. 8, 2006 (DE) 10 2006 027 026.6

(51) Int. Cl. H01J 61/44; C09K 11/71; C09K 11/68; H01J 1/63

(52) U.S. Cl. 313/486; 252/301.4 P; 252/301.5; 313/483; 313/503

(57) ABSTRACT

The invention relates to novel line-emitter phosphors, to a process for the preparation thereof, and to white-emitting illumination units comprising the line-emitter phosphors according to the invention.

The invention relates to novel line-emitter phosphors consisting of europium(III)-doped oxides, to a process for the preparation thereof, and to white-emitting illumination units comprising the line-emitter phosphor according to the invention. The invention furthermore relates to the use of the line-emitter phosphor as conversion phosphor for the conversion of blue or near-UV emission into visible white radiation, and to the use thereof as LED conversion phosphor for white LEDs or so-called colour-on-demand applications.

The colour-on-demand concept is taken to mean the production of light of a certain colour point by means of a pcLED using one or more phosphors. This concept is used, for example, in order to produce certain corporate designs, for example for illuminated company logos, trademarks, etc.

White LEDs are very efficient light sources which consist of a blue-electroluminescent chip essentially comprising InGaN and a phosphor applied above the chip. This phosphor is excited by the blue light and carries out a wavelength conversion to longer wavelengths. Some of the blue light passes through the phosphor (transmission) and combines additively with the fluorescent light from the phosphor to give white light. The phosphors used are, in particular, systems such as garnets, in particular YAG:Ce (emission in the yellow region), and orthosilicates (emission in the green-yellow to yellow-orange region). There has to date been no readily accessible, stable phosphor formulation which also emits intensely in the dark-red region (610-620 nm) on excitation by the blue light from InGaN (440-480 nm) in order to produce “warm” white light in combination with at least one further phosphor, for example the garnets or silicates mentioned above. High-power LEDs (>30 lm/W) are therefore only able to produce white light with cold light temperatures [CCT (correlated colour temperature)>5000 K]. For pleasant room illumination, however, it is necessary, inter alia, to achieve “warmer” colour temperatures of CCT=4200 to 3000 K which have a similar light quality (“feel-good effect”) to halogen bulbs (CCT=3000-4200 K), which have not been surpassed here to date. In addition, it is necessary, for artificial lighting, to facilitate good colour reproduction over the entire visible region so that the illuminated articles exhibit the same colours to the eye as on illumination with natural light. This aspect is important not only for room illumination, but also for the traffic sector. From 2009, LED headlamps for automobiles are expected to become available. It is extremely important here that the colour reproduction of the illuminated objects is very good, so that a red article (traffic sign) which is illuminated with the LED headlamp at night actually appears red and not brown. Fluorescent lamps, which are used for a very wide variety of illumination purposes, contain the red phosphor YOX (Y₂O₃:Eu³⁺). Eu³⁺-based red line-emitting phosphors are known for their very high efficiency and stability, but these phosphors cannot be employed in blue LEDs since efficient excitation must take place in the UV region (wavelengths shorter than 300 nm), and blue LEDs emit in the range from 440 to 470 nm. Although there are concepts for so-called “UV” LEDs, these are, however, very in-effective and have short lifetimes, and in addition the emitted wavelengths are usually in the range from 390 to 405 nm.

As an unsatisfactory solution, sulfides and thiogallates, both doped with Eu²⁺, are employed today as red band-emitting phosphor in LEDs (for example of lumiLEDs). However, these phosphors do not have long-term stability since they undergo hydrolytic decomposition. This occurs even in the encapsulated environment of an LED since moisture is able to diffuse through the plastic encapsulation. Thus, the red fraction in the emitted light from an LED provided with these phosphors constantly decreases due to hydrolysis processes, resulting in the colour point of the light emitted by the LED changing. A complicating factor is that hydrolysis products have a corrosive action and damage the environment of the phosphor, meaning that the lifetime of the LED is relatively limited.

An attempt to solve the above-mentioned problem of red Eu(II)-doped band emitters would be the use of red Eu(III)-doped line-emitter phosphors, which were described for the first time in the 1960s:

In Hans J. Borchardt, J. Chem. Phys. 1963, 39, 504-511 and 1965, 42, 3743-3745, a process is described for the preparation of these phosphors (for example Gd₂(WO₄)₃:Eu³⁺, Gd₂(MoO₄)₃:Eu, Y₂(MoO₄)₃:Eu and GdPO₄:Eu) by the conventional “mixing and firing” method by reaction of the corresponding oxides.

The disadvantage of the Borchardt process is that the resultant phosphors have low homogeneity in respect of the stoichiometric composition (concentration gradients, in particular of the activator Eu³⁺, which can result in concentration extinction), the particle size and the morphology of the particles. Homogeneous and in particular reproducible coating with these particles on an LED chip is thus impossible.

The object of the present invention is therefore to develop a process which does not have the above-mentioned disadvantages since white LEDs can only replace existing illumination technologies (incandescent bulbs, halogen lamps, fluorescent lamps) in areas such as room illumination, traffic and vehicle illumination if red phosphors for LEDs which have long lives and are efficient are available.

Surprisingly, the present object can be achieved by reacting the corresponding starting materials by wet-chemical methods and subsequently subjecting the product to thermal treatment to give the red line-emitter phosphor.

The present invention thus relates to a process for the preparation of a line-emitter phosphor of the formula I

MₐM_{b}′M_{c}″M_{d}′″:EUₑ³⁺, Sr_{f}²⁺, Ba_{g}²⁺, Pbₕ²⁺ (I)
where
M is one or more of the elements Li, Na and/or K,
M′ is one or more of the trivalent rare-earth metals La, Y and/or Gd,
M″ is one or both of the anions MoO₄²⁻, WO₄²⁻,
M′″ is equal to a PO₄³⁻ anion,
0.001≦e≦20 mol %,
0≦f≦30 mol %,
0≦g≦30 mol %,
0≦h≦30 mol %
and furthermore
a) d=0,

a+b=1,
c=1
b) a=0,
b:c:d is equal to 2.4:3:2,

characterized in that the phosphor is prepared by mixing the corresponding starting materials by wet-chemical methods and is subsequently thermally treated.

Wet-chemical preparation generally has the advantage that the resultant materials have higher homogeneity in respect of the stoichiometric composition, the particle size and the morphology of the particles. The particles thus permit more homogeneous coating on the LED chip and facilitate very high internal quantum yields.

For the preparation of the red line-emitter phosphors, starting materials which can be used for the mixture are inorganic and/or organic substances, such as nitrates, carbonates, hydrogencarbonates, phosphates, carboxylates, alcoholates, acetates, oxalates, halides, sulfates, organometallic compounds, hydroxides and/or oxides of the metals, semimetals, transition metals and/or rare earths, which are dissolved and/or suspended in in-organic and/or organic liquids. The starting materials employed here are preferably nitrates, halides and/or phosphates of the corresponding metals, semimetals, transition metals and/or rare earths.

The metals, semimetals, transition metals and/or rare earths employed are preferably the elements gadolinium, tungsten, europium, molybdenum, yttrium, phosphorus and/or sodium.

In accordance with the invention, the dissolved or suspended starting materials are heated for a number of hours with a surface-active agent, preferably a glycol, and the resultant intermediate is isolated at room temperature using an organic precipitation reagent, preferably acetone. After purification and drying of the intermediate, the latter is subjected to thermal treatment at temperatures between 600 and 1200° C. for a number of hours, giving the red line-emitter phosphor as end product.

In a preferred variant of the process, the surface-active agent employed is ethylene glycol.

In a further variant of the process, the dissolved or suspended starting materials, preferably as oxides and/or nitrates, are complexed with a poly-basic carboxylic acid, preferably citric acid, and, after addition of further starting-material solutions, the mixture is evaporated to dryness. After thermal treatment at temperatures between 600° C. and 1200° C., the red line-emitter phosphor is obtained as end product.

In a further preferred variant of the process, the dissolved or suspended starting materials, preferably chlorides and complex oxides, such as molybdates and/or tungstates, optionally with addition of phosphates, are precipitated at elevated temperature in weakly alkaline solution. The precipitate is purified and dried and then subjected to thermal treatment at temperatures between 600 and 1200° C. for a number of hours, giving the red line-emitter phosphor as end product.

The median of the particle-size distribution [Q(x=50%)] of the phosphor particles according to the invention is in a range from [Q(x=50%)]=50 nm to [Q(x=50%)]=20 μm, preferably from [Q(x=50%)]=1 μm to [Q(x=50%)]=15 μm. The particle sizes were determined on the basis of SEM photo-micrographs by determining the particle diameters manually from the digitised SEM images.

The invention furthermore relates to a phosphor of the formula I

MₐM_{b}′M_{c}″M_{d}′″:Euₑ³⁺, Sr_{f}²⁺, Ba_{g}²⁺, Pbₕ²⁺ (I)
where
M is one or more of the elements Li, Na and/or K,
M′ is one or more of the trivalent rare-earth metals La, Y and/or Gd,
M″ is one or both of the anions MoO₄²⁻, WO₄²⁻,
M′″ is equal to a PO₄³⁻ anion,
0.001≦e≦20 mol %,
0≦f≦30 mol %,
0≦g≦30 mol %,
0≦h≦30 mol %
and furthermore
a) d=0,

a+b=1,
c=1
b) a=0,
b:c:d is equal to 2.4:3:2.

The co-doping with large divalent cations, such as strontium, barium or lead, results in increased excitability and photoluminescence. In a further embodiment, f=g=h=0, meaning that the phosphor according to the invention contains no co-dopants Sr, Ba or Pb.

The present invention furthermore relates to a phosphor of the formula I

MₐM_{b}′M_{c}″M_{d}′″:EUₑ³⁺, Sr_{f}²⁺, Ba_{g}²⁺, Pbₕ²⁺ (I)
where
M is one or more of the elements Li, Na and/or K,
M′ is one or more of the trivalent rare-earth metals La, Y and/or Gd,
M″ is one or both of the anions MoO₄²⁻, WO₄²⁻,
M′″ is equal to a PO₄³⁻ anion,
0.001≦e≦20 mol %,
0≦f≦30 mol %,
0≦g≦30 mol %,
0≦h≦30 mol %
and furthermore
a) d=0,

a+b=1,
c=1
b) a=0,
b:c:d is equal to 2.4:3:2,

obtainable by wet-chemical mixing of the corresponding starting materials to give the phosphor precursor, and subsequent thermal treatment, whereby the phosphor precursor is converted into the finished phosphor.

The present invention furthermore relates to a phosphor for the conversion of blue or near-UV emission from a light-emitting element (for example semiconductor element, such as InGaN or AlInGaN) into visible white radiation with high colour reproduction, where the phosphor consists of a mixture of garnet phosphors and the phosphor of the formula I according to the invention, prepared by the wet-chemical process according to the invention.

The red line emitter preferably has a narrowly structured emission between 590 and 700 nm, more preferably between 600 and 660 nm.

The term “garnet phosphors” is taken to mean ternary crystalline compositions having a cubic garnet structure, such as, for example, Y₃Al₅O₁₂ (YAG), which may be doped with, for example, cerium.

The present invention furthermore relates to a phosphor for conversion of blue or near-UV emission from a light-emitting element (for example semiconductor element) into visible white radiation with high colour reproduction, where the phosphor consists of a mixture of orthosilicate phosphors and the red phosphor of the formula I according to the invention, prepared by the wet-chemical process according to the invention.

The term “orthosilicate phosphors” is taken to mean europium(II)-doped phosphors having an orthosilicate matrix, in particular mixed alkaline earth metal orthosilicates.

The red line-emitter phosphors according to the invention can generally be mixed with all common garnet and orthosilicate phosphors, as known to the person skilled in the art from the literature (for example William M. Yen et al., Inorganic Phosphors, CRC Press 2004).

The present invention furthermore relates to an illumination unit having at least one primary light source whose emission maximum is in the range from 190 to 350 nm and/or 365 to 430 nm and/or 430 to 480 nm and/or 520 to 560 nm, where the primary radiation is partially or fully converted into longer-wavelength radiation by a mixture of conversion phosphors and the emitting europium(III)-activated oxide according to the invention. This illumination unit is preferably white-emitting. The conversion phosphors encompass garnet phosphors, orthosilicate phosphors and/or sulfidic phosphors. However, garnet phosphors and orthosilicate phosphors are preferred.

In a preferred embodiment of the illumination unit according to the invention, the light source is a luminescent indium aluminium gallium nitride, in particular of the formula InᵢGaⱼAlₖN, where 0≦i, 0≦j, 0≦k, and i+j+k=1. The illumination unit is preferably white-emitting.

In a further preferred embodiment of the illumination unit according to the invention, the light source is a luminescent compound based on ZnO, TCO (transparent conducting oxide), ZnSe or SiC or a material based on an organic light-emitting layer.

In a further preferred embodiment of the illumination unit according to the invention, the light source is a source which exhibits electroluminescence and/or photoluminescence. The light source can furthermore also be a plasma or discharge source.

The phosphors according to the invention can either be dispersed in a resin (for example epoxy or silicone resin) or, given suitable size conditions, arranged directly on the primary light source, or alternatively arranged remote therefrom, depending on the application (the latter arrangement also includes “remote phosphor technology”). The advantages of remote phosphor technology are known to the person skilled in the art and are revealed, for example, by the following publication: Japanese Journ. of Appl. Phys. Vol. 44, No. 21 (2005), L649-L651.

In a further embodiment, it is preferred for the optical coupling of the illumination unit between the phosphor and the primary light source to be achieved by a light-conducting arrangement. This enables the primary light source to be installed at a central location and to be optically coupled to the phosphor by means of light-conducting devices, such as, for example, light-conducting fibres. In this way, it is possible to achieve lights matched to the illumination wishes, merely consisting of one or different phosphors, which can be arranged to form a light screen, and a light conductor, which is coupled to the primary light source. In this way, it is possible to place a strong primary light source at a location which is favourable for electric installation and to install lights comprising phosphors at any desired locations without further electrical cabling, but instead merely by laying light conductors, with the lights being coupled to the light conductors.

The present invention furthermore relates to the use of the line-emitter phosphor according to the invention for conversion of blue or near-UV emission into visible white radiation. Preference is furthermore given to the use of the phosphors according to the invention for conversion of the primary radiation into a certain colour point by the colour-on-demand concept.

It can be seen from the excitation spectra (see FIGS. 2 and 4) that a different situation prevails in the case of the line-emitter phosphors according to the invention than, for example, in the case of classical red phosphors, such as Y₂O₃:Eu³⁺ or YVO₄:Eu³⁺. In the latter case, the excitation spectrum is dominated by an intense band in the wavelength range 250-300 nm, which is attributed to the respective charge-transfer state, while the absorption bands of the Eu³⁺ ion in the wavelength range >300 nm are only accessible in the case of very sensitive measurements since they result from transitions which are forbidden in quantum-mechanical terms.

In the case of Gd₂(WO₄)₃:Eu³⁺ according to the invention, however, these transitions are clearly evident (FIG. 2; at wavelengths from 380 nm to 420 nm and 450 nm to 470 nm and 530 nm to 550 nm), in addition their intensities are in the region of the intensity of the charge-transfer transition. The phosphors according to the invention can thus be stimulated to emit an intense red luminescence by a blue LED. This applies in particular to the ⁷F_{0.1}→⁵D₂ transition of Eu³⁺ (λ≈466 nm), which can be excited using a blue LED having an emission wavelength of 460 nm-470 nm.

It is clear from the emission spectrum in FIG. 1, for example, that the red line-emitter phosphor according to the invention emits virtually exclusively a very intense red line in the wavelength range 610-620 nm, which results from the ⁵D₀→⁷F₂ transition of Eu³⁺.

The following examples are intended to illustrate the present invention. However, they should in no way be regarded as limiting. All compounds or components which can be used in the compositions are either known and commercially available or can be synthesised by known methods. The temperatures indicated in the examples are always in ° C. It furthermore goes without saying that, both in the description and also in the examples, the added amounts of the components in the compositions always add up to a total of 100%. Percentage data given are always to be regarded in the given context. However, they usually always relate to the weight of the part or total amount indicated.

### EXAMPLES

### Example 1

### Preparation of the Phosphor Na_{0.5}Gd_{0.3}Eu_{0.2}WO₄

2.708 g of gadolinium nitrate hexahydrate and 1.784 g of europium nitrate hexahydrate are dissolved in 100 ml of ethylene glycol [solution 1]. At the same time, a solution of 1.550 g of sodium tungstate dihydrate in 50 ml of deionised water is prepared [solution 2]. 40 ml of solution 1 are initially introduced, and a mixture of 45 ml of solution 2, 45 ml of ethylene glycol and 3 ml of NaOH soln. (1 M) is added dropwise. After the dropwise addition (soln. has a pH of 7.5), the mixture is refluxed for 6 hours.

After the reaction solution has cooled, 200 ml of acetone are added dropwise, the precipitate is subsequently centrifuged off, washed again with acetone and dried in a stream of air, transferred into a porcelain dish and calcined at 600° C. for 5 h.

### Example 2

### Preparation of the Phosphor Na_{0.5}Y_{0.4}Eu_{0.1}MoO₄

3.06 g of yttrium nitrate hexahydrate and 0.892 g of europium nitrate hexahydrate are dissolved in 100 ml of ethylene glycol [solution 1]. At the same time, a solution of 1.210 g of sodium molybdate dihydrate in 50 ml of deionised water is prepared [solution 2]. 20 ml of solution 1 are initially introduced, a mixture of 45 ml of solution 2, 45 ml of ethylene glycol and 3 ml of NaOH soln. (1 M) is added dropwise. After the dropwise addition, the mixture is refluxed for 6 hours.

After the reaction solution has cooled, 200 ml of acetone are added dropwise, the precipitate is subsequently centrifuged off, washed again with acetone and dried in a stream of air.

The batch is transferred into a muffle furnace and calcined therein at 600° C. for 5 hours.

### Example 3

### Preparation of the Phosphor Na_{0.5}La_{0.3}Eu_{0.2}WO₄ (Precipitation Reaction)

2.120 g of lanthanum chloride hexahydrate and 1.467 g of europium chloride hexahydrate are dissolved in 100 ml of deionised water [solution 1]. At the same time, a solution of 4.948 g of sodium tungstate dihydrate in 100 ml of deionised water is prepared [solution 2]. 100 ml of solution 1 are initially introduced, solution 2 is added dropwise thereto (monitor pH, should be in the range 7.5-8, if necessary correct using NaOH solution (1 M)).

The mixture is subsequently refluxed for 6 hours.

After the reaction solution has cooled, the precipitate is filtered off with suction and dried, giving a white precipitate.

The batch is calcined at 600° C. for 5 h.

### Example 4

### Preparation of the Phosphor Na_{0.5}La_{0.3}Eu_{0.2}MoO₄ by Complexing with Citric Acid

1.024 g of molybdenum(IV) oxide are dissolved in 10 ml of H₂O₂ (30%) with gentle warming. 4.608 g of citric acid together with 10 ml of dist. H₂O are added to the yellow soln.

1.040 g of La(NO₃)×6 H₂O and 0.714 g of Eu(NO₃)×6 H₂O and 0.340 g of NaNO₃ are subsequently added, and the mixture is made up to 40 ml.

The yellow solution is dried in a vacuum drying cabinet; a blue foam initially forms, from which a blue powder finally results. The solid is subsequently calcined at 800° C. for 5 hours.

### Example 5

### Preparation of the Phosphor Na_{0.5}La_{0.3}Eu_{0.2}(WO₄)_{0.5} (MoO₄)_{0.5}

2.120 g of lanthanum chloride hexahydrate and 1.467 g of europium chloride hexahydrate are dissolved in 100 ml of deionised water [solution 1]. At the same time, a solution of 1.815 g of sodium molybdate dihydrate and 2.474 g of sodium tungstate dihydrate in 100 ml of deionised water is prepared [solution 2]. 100 ml of solution 1 are initially introduced, solution 2 is added dropwise thereto (pH should be in the range 7.5-8, if necessary correct using NaOH solution (1 M)).

The mixture is subsequently refluxed for 6 hours.

After the reaction solution has cooled, the precipitate is filtered off with suction and dried and subsequently calcined at 600° C. for 5 h.

### Example 6

### Preparation of the Phosphor La_{1.2}Eu_{0.8}MoO₄ by Complexing with Citric Acid

1.024 g of molybdenum(IV) oxide are dissolved in 10 ml of H₂O₂ (30%) with gentle warming. 4.608 g of citric acid together with 10 ml of dist. H₂O are added to the yellow soln.

1.040 g of La(NO₃)×6 H₂O and 0.714 g of Eu(NO₃)×6 H₂O and 0.340 g of NaNO₃ are subsequently added, and the mixture is made up to 40 ml.

The yellow solution is dried in a vacuum drying cabinet; a blue foam initially forms, from which a blue powder finally results. The solid is subsequently calcined at 600° C. for 5 hours.

### Example 7

### Preparation of the Phosphor La_{1.2}Eu_{0.8}WO₄ by Complexing with Citric Acid

0.9711 g of tungsten(IV) oxide is dissolved in 10 ml of H₂O₂ (30%) with gentle warming. At the same time, a solution of 0.7797 g of La(NO₃)₃. 6H₂O, 0.5353 g of Eu(NO₃)₃.6H₂O and 1.8419 g of citric acid in 40 ml of H₂O is prepared and added to the blue tungstate soln.

The blue solution is dried in a vacuum drying cabinet; a blue foam initially forms, from which a blue powder finally results. The solid is subsequently calcined at 600° C. for 5 hours.

### Example 8

### Preparation of the Phosphor (Gd_{0.6}Eu_{0.4})₂(WO₄)_{1.5}PO₄

2.23 g of GdCl₃×6H₂O and 1.465 g of EuCl₃×6H₂O are dissolved in 100 ml of ethylene glycol (solution 1).

1.73 g of Na₂WO₄ are dissolved in 70 ml of H₂O (solution 2).

0.74 g of K₃PO₄ is dissolved in 70 ml of ethylene glycol (solution 3).

100 ml of solution 1 are initially introduced into an Erlenmeyer flask. Firstly 70 ml of solution 3 are added thereto. The solution becomes cloudy, but becomes clear again after brief stirring. A mixture of 70 ml of solution 2 and 5 ml of NaOH soln. (1 M) is subsequently added dropwise.

The reaction mixture is transferred into a three-necked flask and refluxed for at least 6 h with stirring.

250 ml of acetone are added dropwise to the reaction solution. The precipitate is subsequently centrifuged off and washed again with acetone.

The product is then calcined in a furnace at 650° C. for 4 hours.

### DESCRIPTION OF THE FIGURES

The invention will be explained in greater detail below with reference to a number of working examples.

FIG. 1 shows the emission spectrum of the phosphor Na_{0.5}Gd_{0.3}Eu_{0.2}WO₄

FIG. 2 shows the excitation spectrum of the phosphor Na_{0.5}Gd_{0.3}Eu_{0.2}WO₄

FIG. 3 shows the emission spectrum of the phosphor (Gd_{0.6}Eu_{0.4})₂—(WO₄)_{1.5}PO₄

FIG. 4 shows the excitation spectrum of the phosphor (Gd_{0.6}Eu_{0.4})₂—(WO₄)_{1.5}PO₄

FIG. 5 shows the diagrammatic depiction of a light-emitting diode having a phosphor-containing coating. The component comprises a chip-like light-emitting diode (LED) 1 as radiation source. The light-emitting diode is accommodated in a cup-shaped reflector, which is held by an adjustment frame 2. The chip 1 is connected to a first contact 6 via a flat cable 7 and directly to a second electrical contact 6′. A coating comprising a conversion phosphor according to the invention has been applied to the inside curvature of the reflector cup. The phosphors are either employed separately from one another or in the form of a mixture. (List of part numbers: 1 light-emitting diode, 2 reflector, 3 resin, 4 conversion phosphor, 5 diffuser, 6 electrodes, 7 flat cable)

FIG. 6 shows a COB (chip-on-board) package of the InGaN type, which serves as light source (LED) for white light (1=semiconductor chip; 2, 3=electrical connections; 4=conversion phosphor; 7=board). The phosphor is distributed in a binder lens, which at the same time represents a secondary optical element and influences the light emission characteristics as a lens.

FIG. 7 shows a COB (chip-on-board) package of the InGaN type, which serves as light source (LED) for white light (1=semiconductor chip; 2, 3=electrical connections; 4=conversion phosphor; 7=board). The phosphor is distributed directly in a thin binder layer on the LED chip. A secondary optical element consisting of a transparent material can be placed thereon.

FIG. 8 shows a package, which serves as light source (LED) for white light (1=semiconductor chip; 2, 3=electrical connections; 4=conversion phosphor in cavity with reflector). The conversion phosphor is dispersed in a binder, where the mixture fills the cavity.

FIG. 9 shows a package, where 1=housing; 2=electrical connection; 3=lens; 4=semiconductor chip. This design has the advantage that it is a flip-chip design, where a greater proportion of the light from the chip can be used for light purposes via the transparent substrate and a reflector on the base. In addition, heat dissipation is favoured in this design.

FIG. 10 shows a package, where 1=housing; 2=electrical connection; 4=semiconductor chip, and the cavity below the lens is completely filled with the conversion phosphor according to the invention. This package has the advantage that a greater amount of conversion phosphor can be used. This can also act as remote phosphor.

FIG. 11 shows an SMD (surface mounted) package, where 1=housing; 2, 3=electrical connections; 4=conversion layer. The semiconductor chip is completely covered by the phosphor according to the invention. The SMD design has the advantage that it has a small physical shape and thus fits into conventional lights.

FIG. 12 shows a T5 package, where 1=conversion phosphor; 2=chip; 3, 4=electrical connections; 5=lens with transparent resin. The conversion phosphor is located on the reverse of the LED chip, which has the advantage that the phosphor is cooled via the metallic connections.

FIG. 13 shows a diagrammatic depiction of a light-emitting diode where 1=semiconductor chip; 2, 3=electrical connections; 4=conversion phosphor; 5=bond wire, where the phosphor in a binder is applied as top globe. This form of the phosphor/binder layer can act as secondary optical element and can influence, for example, the light propagation.

FIG. 14 shows a diagrammatic depiction of a light-emitting diode, where 1=semiconductor chip; 2, 3=electrical connections; 4=conversion phosphor; 5=bond wire, where the phosphor is applied as a thin layer dispersed in a binder. A further component acting as secondary optical element, such as, for example, a lens, can easily be applied to this layer.

FIG. 15 shows an example of a further application, as is in principle already known from U.S. Pat. No. 6,700,322. The phosphor according to the invention here is used together with an OLED. The light source is an organic light-emitting diode 31, consisting of the actual organic film 30 and a transparent substrate 32. The film 30 emits, in particular, blue primary light, produced, for example, by means of PVK:PBD:coumarin (PVK, abbreviation for poly(n-vinylcarbazole); PBD, abbreviation for 2-(4-biphenyl)-5-(4-tert-butylphenyl)-1,3,4-oxadiazole). The emission is partially converted into yellow, secondarily emitted light by a top layer formed from a layer 33 of the phosphor according to the invention, resulting overall in white emission through colour mixing of the primarily and secondarily emitted light. The OLED essentially consists of at least one layer of a light-emitting polymer or of so-called small molecules between two electrodes consisting of materials known per se, such as, for example, ITO (abbreviation for “indium tin oxide”), as anode and a highly reactive metal, such as, for example, Ba or Ca, as cathode. A plurality of layers is frequently also used between the electrodes, which either serve as hole-transport layers or also serve as electron-transport layers in the region of the small molecules. The emitting polymers used are, for example, polyfluorenes or polyspiro materials.

FIG. 16 shows a low-pressure lamp 20 with a mercury-free gas filling 21 (diagrammatic), an indium filling and a buffer gas analogously to WO 2005/061659, where a layer 22 of the phosphors according to the invention has been applied.

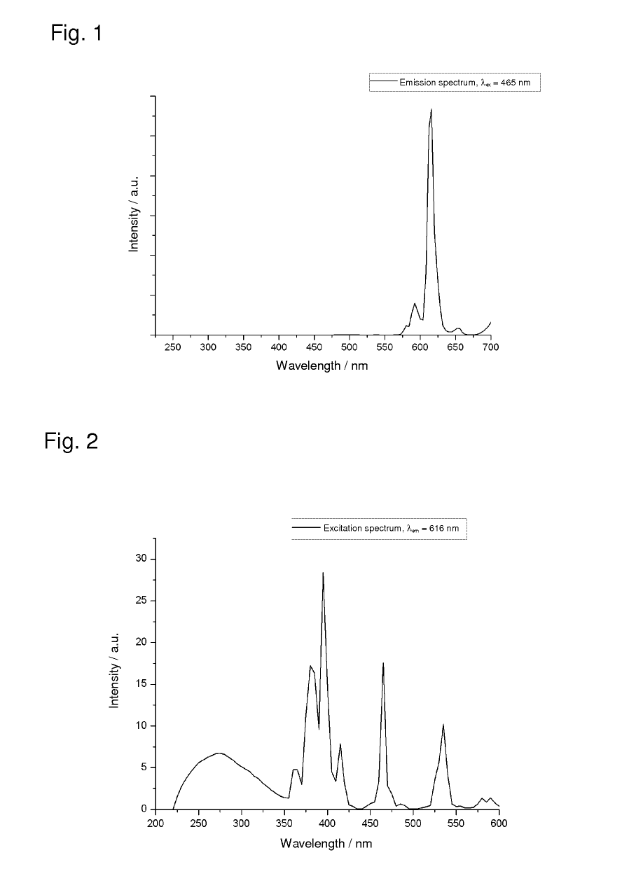

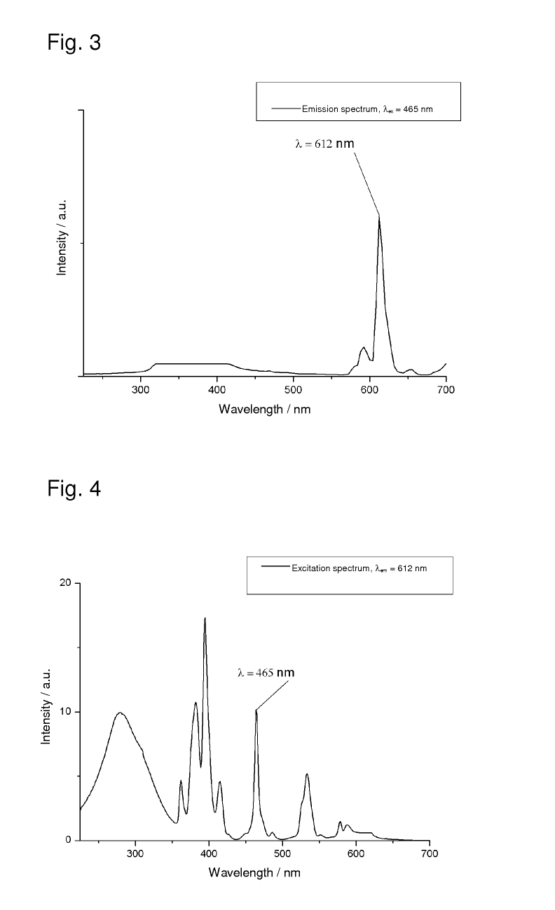

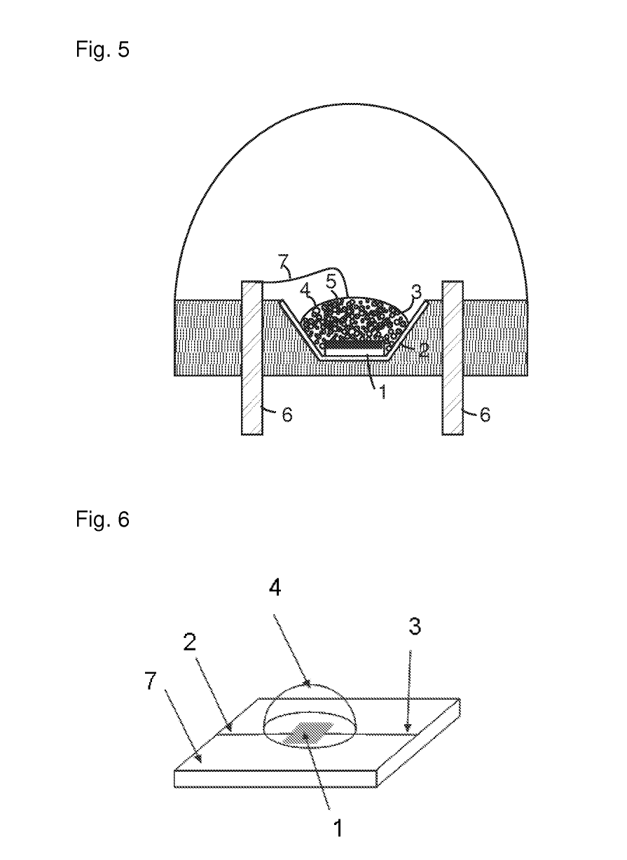

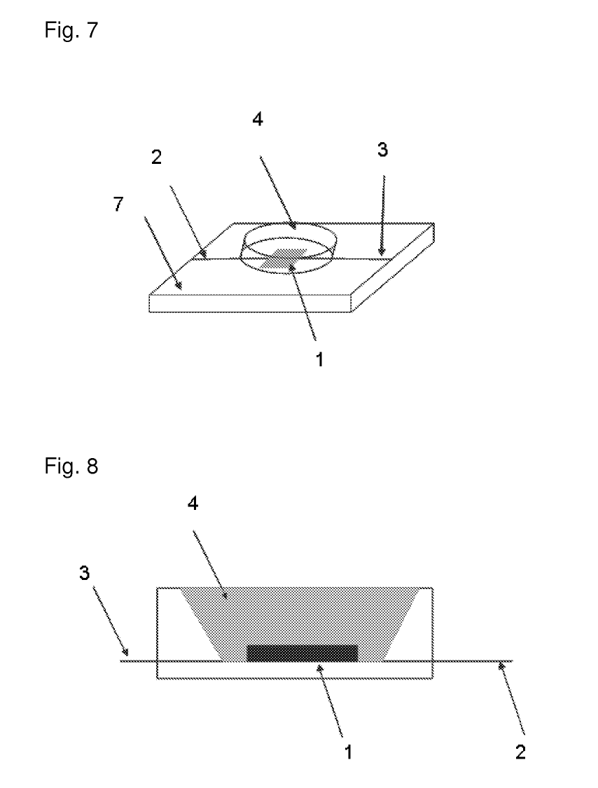

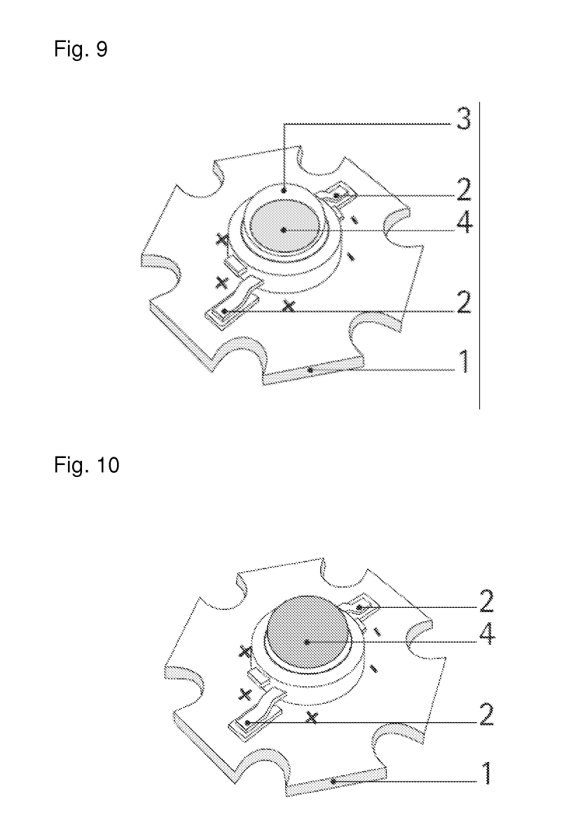

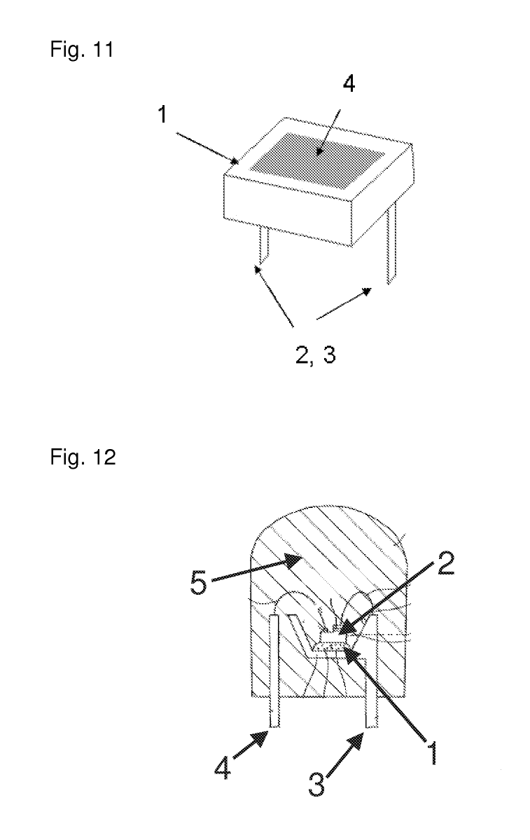

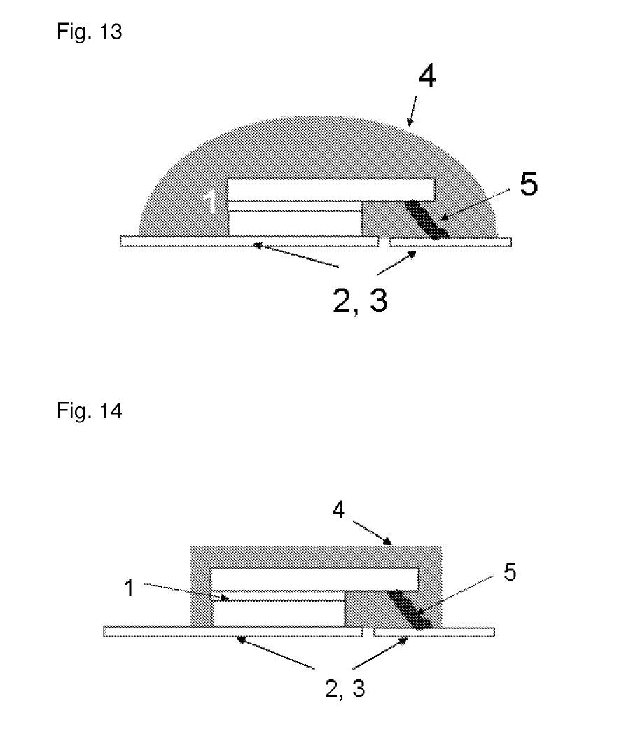

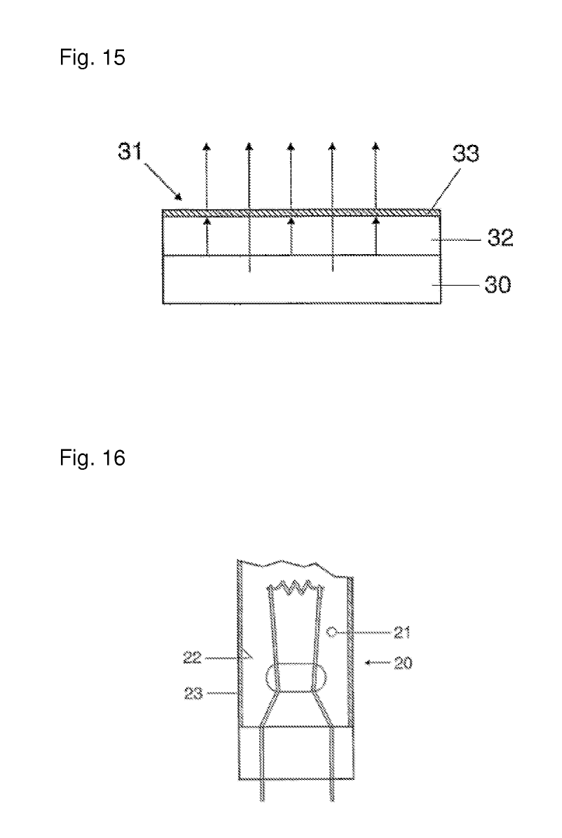

1. Phosphor of the formula I
MₐM_{b}′M_{c}″M_{d}′″:Euₑ³⁺, Sr_{f}²⁺, Ba_{g}²⁺, Pbₕ²⁺ (I)
where
M is one or more of the elements Li, Na and/or K,
M′ is one or more of the trivalent rare-earth metals La, Y and/or Gd,
M″ is one or both of the anions MoO₄²⁻, WO₄²⁻,
M′″ is equal to a PO₄³⁻ anion,
0.001≦e≦20 mol %,
0≦f≦30 mol %,
0≦g≦30 mol %,
0≦h≦30 mol %
and furthermore
a) d=0,
a+b=1,
c=1
b) a=0,
b:c:d is equal to 2.4:3:2.

2. Phosphor according to claim 1, characterized in that f=g=h=0.

3. Phosphor according to claim 1, characterized in that it consists of a mixture of conversion phosphors and a phosphor of the formula I.

4. Phosphor of the formula I
MₐM_{b}′M_{c}″M_{d}′″:Euₑ³⁺, Sr_{f}²⁺, Ba_{g}²⁺, Pbₕ²⁺ (I)
where
M is one or more of the elements Li, Na and/or K,
M′ is one or more of the trivalent rare-earth metals La, Y and/or Gd,
M″ is one or both of the anions MoO₄²⁻, WO₄²⁻,
M′″ is equal to a PO₄³⁻ anion,
0.001≦e≦20 mol %,
0≦f≦30 mol %,
0≦g≦30 mol %,
0≦h≦30 mol %
and furthermore
a) d=0,
a+b=1,
c=1
b) a=0,
b:c:d is equal to 2.4:3:2.
obtainable by wet-chemical mixing of the corresponding starting materials to give the phosphor precursor and subsequent thermal treatment.

5. Process for the preparation of a line-emitter phosphor of the formula I
MₐM_{b}′M_{c}″M_{d}′″:Euₑ³⁺, Sr_{f}²⁺, Ba_{g}²⁺, Pbₕ²⁺ (I)
where
M is one or more of the elements Li, Na and/or K,
M′ is one or more of the trivalent rare-earth metals La, Y and/or Gd,
M″ is one or both of the anions MoO₄²⁻, WO₄²⁻,
M′″ is equal to a PO₄³⁻ anion,
0.001≦e≦20 mol %,
0≦f≦30 mol %,
0≦g≦30 mol %,
0≦h≦30 mol %
and furthermore
a) d=0,
a+b=1,
c=1
b) a=0,
b:c:d is equal to 2.4:3:2,
characterized in that the phosphor is prepared by mixing the corresponding starting materials by wet-chemical methods and is subsequently thermally treated.

6. Process according to claim 5, characterized in that the starting materials used for the mixture are inorganic and/or organic substances, such as nitrates, carbonates, hydrogencarbonates, phosphates, carboxylates, alcoholates, acetates, oxalates, halides, sulfates, organometallic compounds, hydroxides and/or oxides of the metals, semimetals, transition metals and/or rare earths, which are dissolved and/or suspended in inorganic and/or organic liquids.

7. Process according to claim 5, characterized in that the starting materials employed are nitrates, halides and/or phosphates of the corresponding metals, semimetals, transition metals and/or rare earths.

8. Process according to claim 5, characterized in that the metals, semimetals, transition metals and/or rare earths employed are Gd, W, Eu, Mo, Y, P and/or Na.

9. Process according to claim 5, characterized in that the dissolved or suspended starting materials are heated with a surface-active agent (ethylene glycol), and the resultant intermediate is isolated.

10. Process according to claim 5, characterized in that the surface-active agent employed is a glycol.

11. Process according to claim 5, characterized in that the intermediate is subjected to thermal treatment at between 600 and 1200° C. for a number of hours.

12. Illumination unit having at least one primary light source whose emission maximum is in the range from 190 to 350 nm and/or 365 to 430 nm and/or 430 to 480 nm and/or 520 to 560 nm, where this radiation is partially or fully converted into longer-wavelength radiation by a mixture of conversion phosphors and an emitting europium(Ill)-activated oxide.

13. Illumination unit according to claim 12, characterized in that the light source is a luminescent indium aluminium gallium nitride, in particular of the formula InᵢGaⱼAlₖN, where 0≦i, 0≦j, 0≦k, and i+j+k=1.

14. Illumination unit according to claim 12, characterized in that the light source is a luminescent compound based on ZnO, TCO (transparent conducting oxide), ZnSe or SiC.

15. Illumination unit according to claim 12, characterized in that the light source is a material based on an organic light-emitting layer.

16. Illumination unit according to claim 12, characterized in that the light source is a source which exhibits electroluminescence and/or photoluminescence.

17. Illumination unit according to claim 12, characterized in that the light source is a plasma or discharge source.

18. Illumination unit according to claim 12, characterized in that the phosphor is arranged directly on the primary light source and/or remote therefrom.

19. Illumination unit according to claim 12, characterized in that the optical coupling between the phosphor and the primary light source is achieved by a light-conducting arrangement.

20. for conversion of blue or near-UV emission into visible white radiation comprising impinging blue or near-UV light radiation on a phosphor according to claim 1.

21. Use of the phosphor according to claim 1 as conversion phosphor for conversion of the primary radiation into a particular colour point by the colour-on-demand concept.
